(19) United States
(12) Patent Application Publication
(10) Pub. No.: US 2026/0002004 A1
(43) Pub. Date: Jan. 1, 2026

(54) PEROXIDE-VULCANIZABLE COMPOSITIONS AND PARTIALLY CROSSLINKED POLYMER SYSTEM FORMED THEREFROM

(71) Applicant: AVIENT CORPORATION, Avon Lake, OH (US)

(72) Inventors: Jiren GU, Crystal Lake, IL (US); Hochul JUNG, Algonquin, IL (US); Amit KULKARNI, Avon Lake, OH (US); Gerald MEYER, Crystal Lake, IL (US); William PEPE, Ringwood, IL (US)

(21) Appl. No.: 18/993,128

(22) PCT Filed: Jul. 13, 2023
(86) PCT No.: PCT/US2023/070183

§ 371 Date: Jan. 10, 2025

Related U.S. Application Data
(60) Provisional application No. 63/389,579, filed on Jul. 15, 2022.

(51) Int. Cl. C08J 3/24; C08F 279/02; C08F 285/00

(52) U.S. Cl. CPC C08J 3/246; C08F 279/02; C08F 285/00; C08F 2810/20

(57) ABSTRACT

Embodiments of the present disclosure are directed to partially crosslinked polymer system including a vulcanized, silane grafted thermoplastic elastomer and carbon-carbon bond crosslinks. The vulcanized, silane grafted thermoplastic elastomer comprises a polymerized reaction product of vinyl aromatic monomeric units and conjugated diene monomeric units.

### CLAIM OF PRIORITY

This application claims the benefit of U.S. Provisional Patent Application Ser. No. 63/389,579 bearing Attorney Docket Number 1202209 and filed on Jul. 15, 2022, which is hereby incorporated by reference in its entirety.

### TECHNICAL FIELD

Embodiments of the present disclosure are generally related to peroxide-vulcanizable compositions and partially crosslinked polymer systems formed therefrom.

### BACKGROUND

Crosslinked thermoplastic articles may have desirable properties, such as chemical and heat resistance. However, conventional processes used to form thermoplastic articles may require additional steps, time, and materials to achieve the crosslink density and heat resistance required for certain applications in the healthcare, automotive, and electronic fields.

Accordingly, a continual need exists for new and more cost-effective solutions for forming thermoplastic articles that have improved crosslink density and heat resistance.

### SUMMARY

Embodiments of the present disclosure are directed to partially crosslinked polymer system comprising a vulcanized, silane grafted thermoplastic elastomer with carbon-carbon bond crosslinks, which have an advantageous crosslink density and heat resistance without the need for additional processing steps, time, and materials.

In embodiments, the thermoplastic elastomer may have a degree of hydrogenation greater than or equal to about 50%, greater than or equal to about 60%, greater than or equal to about 70%, greater than or equal to about 80%, greater than or equal to about 85%, greater than or equal to about 90%, or even greater than or equal to about 95% based on the unsaturated groups of the conjugated diene monomeric units in the pre-partially hydrogenated thermoplastic elastomer.

According to another embodiment, a peroxide-vulcanizable composition is provided. The peroxide-vulcanizable composition comprises a thermoplastic elastomer and a vulcanization package. The thermoplastic elastomer comprises vinyl aromatic monomeric units and conjugated diene monomeric units. The vulcanization package comprises an organic peroxide and a silane.

According to another embodiment, a process for making a partially crosslinked polymer system comprising a crosslinked reaction product of a thermoplastic elastomer comprising vinyl aromatic monomeric units and conjugated diene monomeric units and a vulcanization package comprising an organic peroxide and a silane is provided. The process comprises blending the thermoplastic elastomer, the organic peroxide, and the silane such that the thermoplastic elastomer includes carbon-carbon bond crosslinks and grafted silane moieties; and shaping the carbon-carbon crosslinked, silane-grafted blend.

Additional features and advantages of the embodiments described herein will be set forth in the detailed description which follows, and in part will be readily apparent to those skilled in the art from that description or recognized by practicing the embodiments described herein, including the detailed description, which follows and the claims.

### DETAILED DESCRIPTION

Reference will now be made in detail to various embodiments of partially crosslinked polymer systems, specifically partially crosslinked polymer systems comprising a vulcanized, silane grafted thermoplastic elastomer with carbon-carbon bond crosslinks. The vulcanized, silane grafted thermoplastic elastomer comprises a polymerized reaction product of vinyl aromatic monomeric units and conjugated diene monomeric units. In embodiment, the partially crosslinked polymer system may be a thermoplastic vulcanizate.

The disclosure should not be construed as limited to the embodiments set forth herein. Rather, these embodiments are provided so that this disclosure will be thorough and complete, and will fully convey the subject matter to those skilled in the art.

### Definitions

Unless otherwise defined, all technical and scientific terms used herein have the same meaning as commonly understood by one of ordinary skill in the art. The terminology used in the disclosure herein is for describing particular embodiments only and is not intended to be limiting.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used in the specification and the appended claims, the singular forms “a,” “an,” and “the” are intended to include the plural forms as well, unless the context clearly indicates otherwise. Thus, for example, reference to “a” component includes aspects having two or more such components, unless the context clearly indicates otherwise.

The term “wt %,” as described herein, refers to the weight fraction of the individual component based on a total weight of the peroxide-vulcanizable composition, unless otherwise noted.

The term “number average molecular weight,” as described herein, refers to total weight of polymer divided by the total number of molecules as measured using gel permeation chromatography (GPC) and polystyrene standards.

The term “melt flow rate,” as described herein, refers to the ability of a material's melt to flow under pressure as measured according to ASTM D1238 at the given temperature and given weight.

The term “density,” as described herein, refers to the mass per unit volume of a material as measured according to ASTM D792 at 23° C.

The term “specific gravity,” as described herein, refers to the ratio of the density of a material to the density of water as measured according to ASTM D792 at 23° C.

The term “Mooney viscosity,” as described herein, refers to the viscosity reached after a rotor rotates for a given time interval at the specified temperature as measured according to ASTM D1646.

The term “yield,” as described herein, refers to the point on a stress-strain curve that indicates the limit of elastic behavior and the beginning of plastic behavior.

The term “tensile strength at yield,” as described herein, refers to the maximum stress that a material can withstand while being stretched before it begins to change shape permanently as measured according to ASTM D638 at 23° C. and a rate of strain of 0.85 mm/s.

The term “tensile elongation at yield,” as described herein, refers to the ratio between the increased length and initial length at the yield point as measured according to ASTM D638 at 23° C. and a rate of strain of 0.85 mm/s.

The term “tensile strength at break,” as described herein, refers to the maximum stress that a material can withstand while stretching before breaking as measured according to ASTM D638 at 23° C. and a rate of strain of 0.85 mm/s.

The term “tensile elongation at break,” as described herein, refers to the ratio between increased length and initial length after breakage as measured according to ASTM D638 at 23° C. and a rate of strain of 0.85 mm/s.

The term “Shore A hardness,” as described herein, refers to the hardness of a material as measured according to ASTM D2240.

The term “compression set,” as described herein, refers to the ability of a material to return to its original thickness after prolonged compressive stress as measured according to ASTM D395 at the temperature indicated.

The term “polyolefin,” as described herein, refers to a polymer has that has a crystalline and amorphous phase made from prepared from olefin monomers.

The term “polyolefin elastomer (POE),” as described herein, refers to a low crystalline (i.e., less than or equal to 25% crystalline) polymer prepared from olefin monomers.

The term “silane grafted,” as described herein, refers to the thermoplastic elastomer having a silane side chain connected to the polymer main chain.

The term “copolymer,” as described herein, refers to a polymer formed when two or more different monomers are polymerized to form a chain.

The term “block,” as described herein, refers to a portion of a polymer, comprising many constitutional units, that has at least one feature which is not present in the adjacent portions.

As discussed hereinabove, crosslinked thermoplastic articles may have desirable properties, such as chemical and heat resistance. However, conventional processes used to form thermoplastic articles may require additional steps, time, and materials to achieve the crosslink density and heat resistance required for certain applications in the healthcare, automotive, and electronic fields.

Disclosed herein are peroxide-vulcanizable compositions, which mitigate the aforementioned problems. Specifically, the peroxide-vulcanizable compositions disclosed herein comprise a of partially crosslinked polymer system comprising a polymerized reaction product of vinyl aromatic monomeric units with conjugated diene monomeric units; and a vulcanization package comprising an organic peroxide and a silane, which results in a of partially crosslinked polymer system having an advantageous crosslink density (i.e., reduced tensile elongation at break) and heat resistance (i.e., reduced compression set). The vulcanization package of both organic peroxide and silane enables carbon-carbon bond crosslinking of the thermoplastic elastomer upon blending (e.g., within the extruder) without the need for additional steps or materials (e.g., moisture cure catalyst).

### Peroxide-Vulcanizable Composition

The peroxide-vulcanizable compositions disclosed herein may generally be described as a thermoplastic elastomer and a vulcanization package.

### Thermoplastic Elastomer

The thermoplastic elastomer of the peroxide-vulcanizable composition comprises vinyl aromatic monomeric units and conjugated diene monomeric units. In embodiments, the conjugated diene monomeric units may be selected from the group consisting of 1,3-butadiene monomeric units, 2,3-dimethyl-1,3-butadiene, piperylene monomeric units, isoprene monomeric units, and combinations thereof. In embodiments, the vinyl aromatic monomeric units may be selected from the group consisting styrene monomeric units, α-methyl styrene monomeric units, p-methylstyrene monomeric units, o-methylstyrene monomeric units, p-butylstyrene monomeric units, p-tertbutylstyrene monomeric units, and combinations thereof.

In embodiments, the thermoplastic elastomer may be selected from the group consisting of styrene-butadiene rubber, styrene-butadiene block copolymers, styrene-isoprene block copolymers, styrene-butadiene-isoprene rubber, styrene-butadiene/isoprene block copolymers, styrene-butadiene-isoprene block copolymers, partially hydrogenated styrene-butadiene rubber, partially hydrogenated styrene-butadiene block copolymers, partially hydrogenated styrene-isoprene block copolymers, partially hydrogenated styrene-butadiene-isoprene rubber, partially hydrogenated styrene-butadiene/isoprene block copolymers, partially hydrogenated styrene-butadiene-isoprene block copolymers, and combinations thereof.

In embodiments, the thermoplastic elastomer may be a block copolymer that includes a block defined by formula (I):

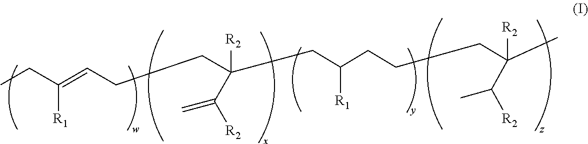

wherein the w, x, y, and z units are randomly distributed in block, each R₁ is independently a hydrogen atom or a methyl group, and each R₂ is independently a hydrogen atom or a methyl group with the proviso that at least one R₂ per unit is a hydrogen atom.

In embodiments including a block copolymer that includes a block defined by formula (I), the molar percent of the sum of the y and z units out of the total sum of the w, x, y, and z units in the block may be from about 30% to about 90%. In embodiments including a block copolymer that includes a block defined by formula (I), the molar percent of the sum of the y and z units out of the total sum of the w, x, y, and z units in the block may be from about 50% to about 70%. In embodiments including a block copolymer that includes a block defined by formula (I), the molar percent of the sum of the y and z units out of the total sum of the w, x, y, and z units in the block may be greater than or equal to about 30%, greater than or equal to about 35%, greater than or equal to about 40%, greater than or equal to about 45%, or even greater than or equal to about 50%. In embodiments including a block copolymer that includes a block defined by formula (I), the molar percent of the sum of the y and z units out of the total sum of the w, x, y, and z units in the block may be less than or equal to about 90%, less than or equal to about 85%, less than or equal to about 80%, less than or equal to about 75%, or even less than or equal to about 70%. In embodiments including a block copolymer that includes a block defined by formula (I), the molar percent of the sum of the y and z units out of the total sum of the w, x, y, and z units in the block may be from about 30% to about 90%, from about 30% to about 85%, from about 30% to about 80%, from about 30% to about 75%, from about 30% to about 70%, from about 35% to about 90%, from about 35% to about 85%, from about 35% to about 80%, from about 35% to about 75%, from about 35% to about 70%, from about 40% to about 90%, from about 40% to about 85%, from about 40% to about 80%, from about 40% to about 75%, from about 40% to about 70%, from about 45% to about 90%, from about 45% to about 85%, from about 45% to about 80%, from about 45% to about 75%, from about 45% to about 70%, from about 50% to about 90%, from about 50% to about 85%, from about 50% to about 80%, from about 50% to about 75%, or even from about 50% to about 70%, or any and all subranges formed from any of these endpoints.

In embodiments including a block copolymer that includes a block defined by formula (I), the ratio of y units to w units may be greater than the ratio of x units to z units. In embodiments including a block copolymer that includes a block defined by formula (I), the ratio of y units to w units may be less than the ratio of x units to z units.

In embodiments, the thermoplastic elastomer may be a block copolymer that includes a block defined by formula (II):

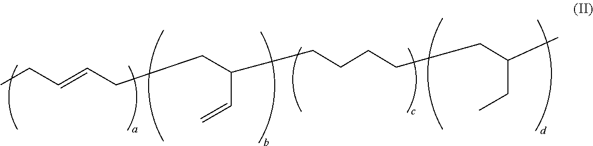

wherein the a, b, c, and d units are randomly distributed in the block.

In embodiments including a block copolymer that includes a block defined by formula (II), the molar percent of the sum of the c units and d units out of the total sum of the a, b, c, and d units in the block may be from about 30% to about 90%. In embodiments including a block copolymer that includes a block defined by formula (II), the molar percent of the sum of the c units and d units out of the total sum of the a, b, c, and d units in the block may be from about 50% to about 70%. In embodiments including a block copolymer that includes a block defined by formula (II), the molar percent of the sum of the c units and d units out of the total sum of the a, b, c, and d units in the block may be greater than or equal to about 30%, greater than or equal to about 35%, greater than or equal to about 40%, greater than or equal to about 45%, or even greater than or equal to about 50%. In embodiments including a block copolymer that includes a block defined by formula (II), the molar percent of the sum of the c units and d units out of the total sum of the a, b, c, and d units in the block may be less than or equal to about 90%, less than or equal to about 85%, less than or equal to about 80%, less than or equal to about 75%, or even less than or equal to about 70%. In embodiments including a block copolymer that includes a block defined by formula (II), the molar percent of the sum of the c units and d units out of the total sum of the a, b, c, and d units in the block may be from about 30% to about 90%, from about 30% to about 85%, from about 30% to about 80%, from about 30% to about 75%, from about 30% to about 70%, from about 35% to about 90%, from about 35% to about 85%, from about 35% to about 80%, from about 35% to about 75%, from about 35% to about 70%, from about 40% to about 90%, from about 40% to about 85%, from about 40% to about 80%, from about 40% to about 75%, from about 40% to about 70%, from about 45% to about 90%, from about 45% to about 85%, from about 45% to about 80%, from about 45% to about 75%, from about 45% to about 70%, from about 50% to about 90%, from about 50% to about 85%, from about 50% to about 80%, from about 50% to about 75%, or even from about 50% to about 70%, or any and all subranges formed from any of these endpoints.

In embodiments including a block copolymer that includes a block defined by formula (II), the ratio of c units to a units may be greater than the ratio of d units to b units. In embodiments including a block copolymer that includes a block defined by formula (II), the ratio of c units to a units may be less than the ratio of d units to b units.

In embodiments, the thermoplastic elastomer may have a number average molecular weight from about 30,000 g/mol to about 400,000 g/mol. In embodiments, the thermoplastic elastomer may have a number average molecular weight greater than or equal to 30,000 g/mol, greater than or equal to about 50,000 g/mol, greater than or equal to about 100,000 g/mol, or even greater than or equal to about 150,000 g/mol. In embodiments, the thermoplastic elastomer may have a number average molecular weight less than or equal to about 400,000 g/mol, less than or equal to about 350,000 g/mol, less than or equal to about 300,000 g/mol, or even less than or equal to about 250,000 g/mol. In embodiments, the thermoplastic elastomer may have a number average molecular weight from about 30,000 g/mol to about 400,000 g/mol, from about 30,000 g/mol to about 350,000 g/mol, from about 30,000 g/mol to about 300,000 g/mol, from about 30,000 g/mol to about 250,000 g/mol, from about 50,000 g/mol to about 400,000 g/mol, from about 50,000 g/mol to about 350,000 g/mol, from about 50,000 g/mol to about 300,000 g/mol, from about 50,000 g/mol to about 250,000 g/mol, from about 100,000 g/mol to about 400,000 g/mol, from about 100,000 g/mol to about 350,000 g/mol, from about 100,000 g/mol to about 300,000 g/mol, from about 100,000 g/mol to about 250,000 g/mol, from about 150,000 g/mol to about 400,000 g/mol, from about 150,000 g/mol to about 350,000 g/mol, from about 150,000 g/mol to about 300,000 g/mol, or even from about 150,000 g/mol to about 250,000 g/mol, or any and all subranges formed from any of these endpoints.

In embodiments, the thermoplastic elastomer may be a triblock copolymer that includes two polystyrene end blocks. In such embodiments, the styrene content of the two polystyrene end blocks in the thermoplastic elastomer may be from about 10 wt % to about 50 wt %. In embodiments, the styrene content of the two polystyrene end blocks in the thermoplastic elastomer may be greater than or equal to about 10 wt %, greater than or equal to about 15 wt %, greater than or equal to about 20 wt %, greater than or equal to about 25 wt %, or even greater than or equal to about 27 wt %. In embodiments, the styrene content of the two polystyrene end blocks in the thermoplastic elastomer may be less than or equal to about 50 wt %, less than or equal to about 45 wt %, less than or equal to about 40 wt %, less than or equal to about 35 wt %, or even less than or equal to about 33 wt %. In embodiments, the styrene content of the two polystyrene end blocks in the thermoplastic elastomer may be from about 10 wt % to about 50 wt %, from about 10 wt % to about 45 wt %, from about 10 wt % to about 40 wt %, from about 10 wt % to about 35 wt %, from about 10 wt % to about 33 wt %, from about 15 wt % to about 50 wt %, from about 15 wt % to about 45 wt %, from about 15 wt % to about 40 wt %, from about 15 wt % to about 35 wt %, from about 15 wt % to about 33 wt %, from about 20 wt % to about 50 wt %, from about 20 wt % to about 45 wt %, from about 20 wt % to about 40 wt %, from about 20 wt % to about 35 wt %, from about 20 wt % to about 33 wt %, from about 25 wt % to about 50 wt %, from about 25 wt % to about 45 wt %, from about 25 wt % to about 40 wt %, from about 25 wt % to about 35 wt %, from about 25 wt % to about 33 wt %, from about 27 wt % to about 50 wt %, from about 27 wt % to about 45 wt %, from about 27 wt % to about 40 wt %, from about 27 wt % to about 35 wt %, or even from about 27 wt % to about 33 wt %, or any and all subranges formed from any of these endpoints.

In embodiments, the thermoplastic elastomer may be partially hydrogenated. Without being bound by theory, it is believed that crosslinking of partially hydrogenated thermoplastic elastomers occurs at the unhydrogenated sites (i.e., carbon-carbon double bonds located on the conjugated diene residues) and the amount of reactive sites may be set by tailoring the hydrogenation of the thermoplastic elastomer. By controlling the level of hydrogenation the amount of crosslinking may also be controlled. Reducing the degree of hydrogenation of the thermoplastic elastomer may improve the crosslink density and heat resistance of the resulting partially crosslinked polymer system. In embodiments, the thermoplastic elastomer may have a degree of hydrogenation greater than or equal to about 50%, greater than or equal to about 60%, greater than or equal to about 70%, greater than or equal to about 80%, greater than or equal to about 85%, greater than or equal to about 90%, or even greater than or equal to about 95% based on the unsaturated groups of the conjugated diene monomeric units in the pre-partially hydrogenated thermoplastic elastomer. In embodiments, the thermoplastic elastomer may have a degree of hydrogenation in the range of about 30% to about 99%, or about 35% to about 95%, or about 40% to about 90%, or about 45% to about 85%, or about 50% to about 80%, or about 55% to about 75%, based on the unsaturated groups of the conjugated diene monomeric units in the pre-partially hydrogenated thermoplastic elastomer.

In embodiments, the thermoplastic elastomer may be a partially hydrogenated block copolymer having a hard phase and a soft phase, the general configuration being:

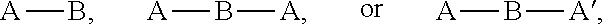

wherein prior to hydrogenation, each A and A′ blocks is a hard phase comprised of vinyl aromatic monomeric units and each B block is a soft phase comprised of conjugated diene monomeric units. “Hard phase” refers to a portion of the block copolymer having a glass transition temperature from 90° C. to 165° C. “Soft phase” refers to a portion of the block copolymer having a glass transition less than −20° C.

In embodiments, the peroxide-vulcanizable composition may comprise from about 25 wt % to about 95 wt % of the thermoplastic elastomer, or from about 30 wt % to about 90 wt % of the thermoplastic elastomer, or from about 35 wt % to about 85 wt % of the thermoplastic elastomer, or from about 40 wt % to about 80 wt % of the thermoplastic elastomer, or from about 50 wt % to about 75 wt % of the thermoplastic elastomer, or from about 60 wt % to about 70 wt % of the thermoplastic elastomer. In embodiments, the amount of thermoplastic elastomer in the peroxide-vulcanizable composition may be greater than or equal to about 25 wt %, greater than or equal to about 30 wt %, greater than or equal to about 35 wt %, greater than or equal to about 40 wt %, greater than or equal to about 50 wt %, or even greater than or equal to about 60 wt %. In embodiments, the amount of thermoplastic elastomer in the peroxide-vulcanizable composition may be less than or equal to about 80 wt %, less than or equal to about 75 wt %, less than or equal to about 70 wt %, less than or equal to 60 wt %, or even less than or equal to about 50 wt %. In embodiments, the amount of thermoplastic elastomer in the peroxide-vulcanizable composition may be from about 25 wt % to about 80 wt %, from about 25 wt % to about 75 wt %, from about 25 wt % to about 70 wt %, from about 25 wt % to about 60 wt %, from about 25 wt % to about 50 wt %, from about 30 wt % to about 80 wt %, from about 30 wt % to about 75 wt %, from about 30 wt % to about 70 wt %, from about 30 wt % to about 60 wt %, from about 30 wt % to about 50 wt %, from about 35 wt % to about 80 wt %, from about 35 wt % to about 75 wt %, from about 35 wt % to about 70 wt %, from about 35 wt % to about 60 wt %, from about 35 wt % to about 50 wt %, from about 40 wt % to about 80 wt %, from about 40 wt % to about 75 wt %, from about 40 wt % to about 70 wt %, from about 40 wt % to about 60 wt %, from about 40 wt % to about 50 wt %, from about 50 wt % to about 80 wt %, from about 50 wt % to about 75 wt %, from about 50 wt % to about 70 wt %, from about 50 wt % to about 60 wt %, from about 60 wt % to about 80 wt %, from about 60 wt % to about 75 wt %, or even from about 60 wt % to about 70 wt %, or any and all subranges formed from any of these endpoints.

Suitable commercial embodiments of the thermoplastic elastomer are available under the VECTOR brand from TSRC, such as styrene-butadiene-styrene (SBS) grade 2518 and styrene-isoprene-styrene (SIS) grade 4211; under the HYBRAR brand from Kuraray, such as styrene-isoprene-styrene (SIS) grade 5127; under the KRATON brand from Kraton, such as partially hydrogenated styrene-butadiene-styrene (SBS) grades G1654 and G1652; and under the TUFTEC brand from Ashai Kasei, such as partially hydrogenated styrene-butadiene-styrene (SBS) grade P 1083.

### Vulcanization Package

The vulcanization package of the peroxide-vulcanizable composition comprises an organic peroxide and a silane. As described herein, the vulcanization package facilitates peroxide vulcanization resulting in carbon-carbon bond crosslinking of the thermoplastic elastomer upon blending without the need for additional steps or materials.

During blending of the peroxide-vulcanizable composition to form the partially crosslinked polymer system, the thermoplastic elastomer may be grafted with silane moieties. The blend may be aged (e.g., heat treated or cured moisture cured) such that the partially crosslinked polymer system forms silane crosslinks from the silane-grafts.

Various silanes are considered suitable for the present peroxide-vulcanizable composition. In embodiments, the silane may be defined by the following formula

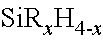

Wherein x is 1-4, and each R is individually a monovalent hydrocarbon group or a monovalent alkoxy group. In embodiments, the monovalent hydrocarbon group may be a linear, cyclic, or branched group. In embodiments, the monovalent hydrocarbon group may include an aromatic group. In embodiments, the monovalent hydrocarbon group may have 1-12 carbon atoms, 2-10 carbon atoms, or 3-8 carbon atoms. In embodiments, the monovalent hydrocarbon group may include double carbon-carbon bonds. In embodiments, the monovalent alkoxy group is a monovalent hydrocarbon group attached to an oxygen atom. The monovalent hydrocarbon group of the monovalent alkoxy group may be a linear, cyclic, or branched group. In embodiments, the monovalent hydrocarbon group of the monovalent alkoxy group may include an aromatic group. In embodiments, the monovalent hydrocarbon group of the monovalent alkoxy group may have 1-12 carbon atoms, 2-10 carbon atoms, or 3-8 carbon atoms. In embodiments, the monovalent hydrocarbon group of the monovalent alkoxy group may include double carbon-carbon bonds.

In embodiments, the silane may comprise vinyl trialkoxysilane. For example, in embodiments, the silane may comprise vinyl trimethoxysilane, vinyl triethoxysilane, or a combination thereof.

In embodiments, the silane may have a specific gravity greater than or equal to about 0.90 or even greater than or equal to about 0.95. In embodiments, the silane may have a specific gravity less than or equal to about 1.05 or even less than or equal to about 1. In embodiments, the silane may have a specific gravity from about 0.90 to about 1.05, from about 0.90 to about 1.00, from about 0.95 to about 1.05, or even from about 0.95 to about 1.00, or any and all subranges formed from any of these endpoints.

In embodiments, the silane may have a boiling point greater than or equal to about 75° C. or even greater than or equal to about 100° C. In embodiments, the silane may have a boiling point less than or equal to about 150° C. or even less than or equal to about 125° C. In embodiments, the silane may have a boiling point from about 75° C. to about 150° C., from about 75° C. to about 125° C., from about 100° C. to about 150° C., or even from about 100° C. to about 125° C., or any and all subranges formed from any of these endpoints.

In embodiments, the silane may have a number average molecular weight greater than or equal to about 50 g/mol, greater than or equal to about 100 g/mol, greater than or equal to 150 g/mol, or even greater than or equal to about 200 g/mol. In embodiments, the silane may have a number average molecular weight less than or equal to about 500 g/mol, less than or equal to about 400 g/mol, or even less than or equal to about 300 g/mol. In embodiments, the silane may have a number average molecular weight from about 50 g/mol to about 500 g/mol, from about 50 g/mol to about 400 g/mol, from about 50 g/mol to about 300 g/mol, from about 100 g/mol to about 500 g/mol, from about 100 g/mol to about 400 g/mol, from about 100 g/mol to about 300 g/mol, from about 150 g/mol to about 500 g/mol, from about 150 g/mol to about 400 g/mol, from about 150 g/mol to about 300 g/mol, from about 200 g/mol to about 500 g/mol, from about 200 g/mol to about 400 g/mol, or even from about 200 g/mol to about 300 g/mol, or any and all subranges formed from any of these endpoints.

In embodiments, the peroxide-vulcanizable composition may comprise from about 0.5 wt % to about 5 wt % of the silane. In embodiments, the amount of silane in the peroxide-vulcanizable composition may be greater than or equal to about 0.5 wt % or even greater than or equal to about 1 wt %. In embodiments, the amount of silane in the peroxide-vulcanizable composition may be less than or equal to about 5 wt %, less than or equal to about 4 wt %, or even less than or equal to about 3 wt %. In embodiments, the amount of silane in the peroxide-vulcanizable composition may be from about 0.5 wt % to about 5 wt %, from about 0.5 wt % to about 4 wt %, from about 0.5 wt % to about 3 wt %, from about 1 wt % to about 5 wt %, from about 1 wt % to about 4 wt %, or even from about 1 wt % to about 3 wt %, or any and all subranges formed from any of these endpoints.

Suitable commercial embodiments of the silane are available under the SILQUEST brand from Momentive, such as grade A-171.

Various organic peroxides are considered suitable for the present peroxide-vulcanizable composition. In embodiments, the organic peroxide may be defined by the following formula

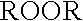

Wherein each R is individually a monovalent hydrocarbon group. In embodiments, the monovalent hydrocarbon group of the organic peroxide may be a linear, cyclic, or branched group. In embodiments, the monovalent hydrocarbon group of the organic peroxide may include an aromatic group. In embodiments, the monovalent hydrocarbon group of the organic peroxide may have 1-16 carbon atoms, 3-12 carbon atoms, or 5-10 carbon atoms. In embodiments, the monovalent hydrocarbon group of the organic peroxide may include double carbon-carbon bonds. In embodiments, the organic peroxide may comprise peroxyketal peroxide, di-tert alkyl peroxide, or a combination thereof. In embodiments, the di-tert alkyl peroxide may comprise dicumyl peroxide.

In embodiments, the organic peroxide may have a density greater than or equal to about 1.00 g/cm³ or even greater than or equal to about 1.05 g/cm³. In embodiments, the organic peroxide may have a density less than or equal to about 1.20 g/cm³ or even less than or equal to about 1.15 g/cm³. In embodiments, the organic peroxide may have a density from about 1.00 g/cm³ to about 1.20 g/cm³, from about 1.00 g/cm³ to about 1.15 g/cm³, from about 1.05 g/cm³ to about 1.20 g/cm³, or even from about 1.05 g/cm³ to about 1.15 g/cm³, or any and all subranges formed from any of these endpoints.

While not wishing to be bound by theory, it is believed that increasing the organic peroxide amount in the peroxide-vulcanizable composition improves the crosslink density and heat resistance of the resulting partially crosslinked polymer system. In embodiments, the peroxide-vulcanizable composition may comprise from about 0.05 wt % to about 1 wt % of the organic peroxide. In embodiments, the amount of organic peroxide in the peroxide-vulcanizable composition may be greater than or equal to about 0.05 wt %, greater than or equal to about 0.1 wt %, or even greater than or equal to about 0.2 wt %. In embodiments, the amount of organic peroxide in the peroxide-vulcanizable composition may be less than or equal to about 1 wt %, less than or equal to about 0.8 wt %, less than or equal to about 0.6 wt %, or even less than or equal to about 0.4 wt %. In embodiments, the amount of organic peroxide in the peroxide-vulcanizable composition may be from about 0.05 wt % to about 1 wt %, from about 0.05 wt % to about 0.8 wt %, from about 0.05 wt % to about 0.6 wt %, from about 0.05 wt % to about 0.4 wt %, from about 0.1 wt % to about 1 wt %, from about 0.1 wt % to about 0.8 wt %, from about 0.1 wt % to about 0.6 wt %, from about 0.1 wt % to about 0.4 wt %, from about 0.2 wt % to about 1 wt %, from about 0.2 wt % to about 0.8 wt %, from about 0.2 wt % to about 0.6 wt %, or even from about 0.2 wt % to about 0.4 wt %, or any and all subranges formed from any of these endpoints.

Suitable commercial embodiments of the organic peroxide are available under the PERKADOX brand from AkzoNobel, such as grade BC-FF.

### Olefin Polymer

In embodiments, the peroxide-vulcanizable composition may further comprise olefin polymer to tailor hardness and mechanical properties and improve flow properties.

In embodiments, the olefin polymer may comprise polyolefin, polyolefin elastomer, or a combination thereof.

In embodiments, the polyolefin may comprise polypropylene, polyethylene, or a combination thereof.

In embodiments, the polyolefin may comprise polypropylene. In embodiments, the polypropylene may comprise a polypropylene homopolymer (i.e., composed of propylene monomers) or a polypropylene copolymer having greater than 50 wt % propylene monomer and an one or more additional comonomer such as C₂ and C₄-C₁₂ alpha olefins.

In embodiments, the polyethylene may comprise a polyethylene homopolymer (i.e., composed of ethylene monomers) or a polyethylene copolymer having greater than 50 wt % ethylene monomer and an additional comonomer, such as C₃-C₁₂ alpha olefins.

In embodiments, the polyolefin is at least one of high density polyethylene (e.g., greater than or equal to 0.940 g/cm³) or a crystalline polypropylene with a percent crystallinity of at least about 60%.

In embodiments, the polypropylene may comprise a melt flow rate (230° C./2.16 kg) greater than or equal to about 0.1 g/10 min, greater than or equal to about 0.5 g/10 min, greater than or equal to about 1 g/10 min, or even greater than or equal to about 3 g/10 min. In embodiments, the polypropylene may comprise a melt flow rate (230° C./2.16 kg) less than or equal to about 10 g/10 min or even less than or equal to about 5 g/10 min. In embodiments, the polypropylene may comprise a melt flow rate (230° C./2.16 kg) from about 0.1 g/10 min to about 10 g/10 min, from about 0.1 g/10 min to about 5 g/10 min, from about 0.5 g/10 min to about 10 g/10 min, from about 0.5 g/10 min to about 5 g/10 min, from about 1 g/10 min to about 10 g/10 min, from about 1 g/10 min to about 5 g/10 min, from about 3 g/10 min to about 10 g/10 min, or even from about 3 g/10 min to about 5 g/10 min, or any and all subranges formed from any of these endpoints.

In embodiments, the polyolefin may comprise a density greater than or equal to about 0.80 g/cm³ or even greater than or equal to about 0.85 g/cm³. In embodiments, the polyolefin may comprise a density less than or equal to about 1.10 g/cm³ or even less than or equal to about 1.00 g/cm³. In embodiments, the polyolefin may comprise a density from about 0.80 g/cm³ to about 1.10 g/cm³, from about 0.80 g/cm³ to about 1.00 g/cm³, from about 0.85 g/cm³ to about 1.10 g/cm³, or even from about 0.85 g/cm³ to about 1.00 g/cm³, or any and all subranges formed from any of these endpoints.

In embodiments, the polyolefin may have a melting point greater than or equal to about 100° C., greater than or equal to about 110° C., or even greater than or equal to about 120° C.

In embodiments, the polyolefin may comprise a tensile strength at yield greater than or equal to about 25 MPa or even greater than or equal to about 30 MPa. In embodiments, the polyolefin may comprise a tensile strength at yield less than or equal to about 45 MPa or even less than or equal to about 40 MPa. In embodiments, the polyolefin may comprise a tensile strength at yield from about 25 MPa to about 45 MPa, from about 25 MPa, to about 40 MPa, from about 30 MPa to about 45 MPa, or even from about 30 MPa to about 40 MPa, or any and all subranges formed from any of these endpoints.

In embodiments, the polyolefin may comprise a tensile elongation at yield greater than or equal to about 3% or even greater than or equal to about 5%. In embodiments, the polyolefin may comprise a tensile elongation at yield less than or equal to about 20% or even less than or equal to about 15%. In embodiments, the polyolefin may comprise a tensile elongation at yield from about 3% to about 20%, from about 3% to about 15%, from about 5% to about 20%, or even from about 5% to about 15%, or any and all subranges formed from any of these endpoints.

Suitable commercial embodiments of the polyolefin are available under the FORMOLENE brand from Formosa Plastics, such as polypropylene homopolymer grade 1102KR. In embodiments, the polyolefin elastomer may comprise polypropylene elastomer.

Suitable commercial embodiments of the polyolefin are available under the VISTAMAXX brand from Exxon, such as polypropylene elastomer grades Vistamaxx 6201 and 6202.

In embodiments, the polyolefin elastomer may comprise olefin block copolymer, ethylene alpha-olefin copolymer, or a combination thereof. In embodiments, the polyolefin elastomer may comprise olefin block copolymer. In embodiments, the polyolefin elastomer may comprise ethylene alpha-olefin copolymer. In embodiments, the polyolefin elastomer may comprise olefin block copolymer and ethylene alpha-olefin copolymer.

In embodiments, the olefin block copolymer may comprise an ethylene alpha-olefin repeating unit. The ethylene alpha-olefin repeating unit is the polymerized reaction product of ethylene and C₃-C₁₂ olefins. For example, in embodiments, the ethylene alpha-olefin repeating unit may comprise ethylene-octene copolymer, ethylene-hexene copolymer, ethylene-butene copolymer, or a combination thereof.

In embodiments, the olefin block copolymer may have a melt flow rate (190° C./2.16 kg) greater than or equal to about 1 g/10 min or even greater than or equal to about 5 g/10 min. In embodiments, the olefin block copolymer may have a melt flow rate (190° C./2.16 kg) less than or equal to about 25 g/10 min or even less than or equal to about 20 g/10 min. In embodiments, the olefin block copolymer may have a melt flow rate (190° C./2.16 kg) from about 1 g/10 min to about 25 g/10 min, from about 1 g/10 min to about 20 g/10 min, from about 5 g/10 min to about 25 g/10 min, or even from about 5 g/10 min to about 20 g/10 min, or any and all subranges formed from any of these endpoints.

In embodiments, the olefin block copolymer may have a density greater than or equal to about 0.80 g/cm³ or even greater than or equal to about 0.85 g/cm³. In embodiments, the olefin block copolymer may have a density less than or equal to about 0.95 g/cm³ or even less than or equal to about 0.90 g/cm³. In embodiments, the olefin block copolymer may have a density from about 0.80 g/cm³ to about 0.95 g/cm³, from about 0.80 g/cm³ to about 0.90 g/cm³, from about 0.85 g/cm³ to about 0.95 g/cm³, or even from about 0.85 g/cm³ to about 0.90 g/cm³, or any and all subranges formed from any of these endpoints.

In embodiments, the olefin block copolymer may have a Shore A hardness greater than or equal to about 50 or even greater than or equal to about 60. In embodiments, the olefin block copolymer may have a Shore A hardness less than or equal to about 85 or even less than or equal to about 75. In embodiments, the olefin block copolymer may have a Shore A hardness from about 50 to about 85, from about 50 to about 75, from about 60 to about 85, or even from about 60 to about 75, or any and all subranges formed from any of these endpoints.

Suitable commercial embodiments of olefin block copolymer are available under the Infuse brand, such as 9500 and 9817, from Dow Chemical Company.

The ethylene alpha-olefin copolymer is the polymerized reaction product of ethylene and C₃-C₁₂ olefins. For example, in embodiments, the ethylene alpha-olefin copolymer may comprise ethylene-octene copolymer, ethylene-hexene copolymer, ethylene-butene copolymer, or a combination thereof.

In embodiments, the ethylene-alpha olefin copolymer may have a melt flow rate (190° C./2.16 kg) greater than or equal to 0.1 g/10 min or even greater than or equal to 0.25 g/10 min. In embodiments, the ethylene-alpha olefin copolymer may have a melt flow rate (190° C./2.16 kg) less than or equal to 3 g/10 min or even less than or equal to 1 g/10 min. In embodiments, the ethylene-alpha olefin copolymer may have a melt flow rate (190° C./2.16 kg) from 0.1 g/10 min to 3 g/10 min, from 0.1 g/10 min to 1 g/10 min, from 0.25 g/10 min to 3 g/10 min, or even from 0.25 g/10 min to 1 g/10 min, or any and all subranges formed from any of these endpoints.

In embodiments, the ethylene-alpha olefin copolymer may have a density greater than or equal to 0.80 g/cm³ or even greater than or equal to 0.85 g/cm³. In embodiments, the ethylene-alpha olefin copolymer may have a density less than or equal to 0.95 g/cm³ or even less than or equal to 0.90 g/cm³. In embodiments, the ethylene-alpha olefin copolymer may have a density from 0.80 g/cm³ to 0.95 g/cm³, from 0.80 g/cm³ to 0.90 g/cm³, from 0.85 g/cm³ to 0.95 g/cm³, or even from 0.85 g/cm³ to 0.90 g/cm³, or any and all subranges formed from any of these endpoints.

In embodiments, the ethylene-alpha olefin copolymer may have a Mooney viscosity (ML 1+4, 121° C.) greater than or equal to 20, greater than or equal to 30, or even greater than or equal to 40. In embodiments, the ethylene-alpha olefin copolymer may have a Mooney viscosity (ML 1+4, 121° C.) less than or equal to 70, less than or equal to 60, or even less than or equal to 50. In embodiments, the ethylene-alpha olefin copolymer may have a Mooney viscosity (ML 1+4, 121° C.) from 20 to 70, from 20 to 60, from 20 to 50, from 30 to 70, from 30 to 60, from 30 to 50, from 40 to 70, from 40 to 60, or even from 40 to 50, or any and all subranges formed from any of these endpoints.

In embodiments, the ethylene-alpha olefin copolymer may have a Shore A hardness greater than or equal to 40 or even greater than or equal to 45. In embodiments, the ethylene-alpha olefin copolymer may have a Shore A hardness less than or equal to 60 or even less than or equal to 65. In embodiments, the ethylene-alpha olefin copolymer may have a Shore A hardness from 40 to 60, from 40 to 55, from 45 to 60, or even from 45 to 55, or any and all subranges formed from any of these endpoints.

Suitable commercial embodiments of the ethylene-alpha olefin copolymer are available under the Engage brand, such as XLT 8677, from Dow Chemical Company.

In embodiments, the peroxide-vulcanizable composition may comprise from about 2 wt % to about 50 wt % of the olefin polymer, from about 4 wt % to about 40 wt % of the olefin polymer, or from about 6 wt % to about 30 wt % of the olefin polymer. In embodiments, the amount of olefin polymer in the peroxide-vulcanizable composition may be greater than or equal to about 2 wt %, greater than or equal to about 4 wt %, or even greater than or equal to about 6 wt %. In embodiments, the amount of olefin polymer in the peroxide-vulcanizable composition may be less than or equal to about 50 wt %, less than or equal to about 40 wt %, less than or equal to about 30 wt %, less than or equal to about 20 wt %, less than or equal to about 17 wt %, less than or equal to about 15 wt %, less than or equal to about 13 wt %, or even less than or equal to about 10 wt %. In embodiments, the amount of olefin polymer in the peroxide-vulcanizable composition may be from about 2 wt % to about 50 wt %, from about 2 wt % to about 40 wt %, from about 2 wt % to about 30 wt %, from about 2 wt % to about 20 wt %, from about 2 wt % to about 17 wt %, from about 2 wt % to about 15 wt %, from about 2 wt % to about 13 wt %, from about 2 wt % to about 10 wt %, from about 4 wt % to about 50 wt %, from about 4 wt % to about 40 wt %, from about 4 wt % to about 30 wt %, from about 4 wt % to about 20 wt %, from about 4 wt % to about 17 wt %, from about 4 wt % to about 15 wt %, from about 4 wt % to about 13 wt %, from about 4 wt % to about 10 wt %, from about 6 wt % to about 50 wt %, from about 6 wt % to about 40 wt %, from about 6 wt % to about 30 wt %, from about 6 wt % to about 20 wt %, from about 6 wt % to about 17 wt %, from about 6 wt % to about 15 wt %, from about 6 wt % to about 13 wt %, or even from about 6 wt % to about 10 wt %, or any and all subranges formed from any of these endpoints.

### Plasticizer

In embodiments, the peroxide-vulcanizable composition may further comprise plasticizer. The plasticizer may help to improve flow in the peroxide-vulcanizable composition.

In embodiments, the plasticizer may comprise non-polar plasticizer (e.g., mineral oil).

In embodiments, the peroxide-vulcanizable composition may comprise from about 10 wt % to about 60 wt % of the plasticizer, or from about 15 wt % to about 55 wt % of the plasticizer, or from about 20 wt % to about 50 wt % of the plasticizer. In embodiments, the amount of plasticizer in the peroxide-vulcanizable composition may be greater than or equal to about 10 wt %, greater than or equal to about 15 wt %, greater than or equal to about 20 wt %, greater than or equal to about 25 wt %, greater than or equal to about 30 wt %, or even greater than or equal to about 35 wt %. In embodiments, the amount of plasticizer in the peroxide-vulcanizable composition may be less than or equal to about 60 wt %, less than or equal to about 55 wt %, less than or equal to about 50 wt %, less than or equal to about 45 wt %, less than or equal to about 40 wt %, less than or equal to about 35 wt %, or even less than or equal to about 30 wt %. In embodiments, the amount of plasticizer in the peroxide-vulcanizable composition may be from about 10 wt % to about 60 wt %

Suitable commercial embodiments of the plasticizer are available under the PURETOL brand from Petro-Canada, such as grade PSO 380.

### Tackifier

In embodiments, the peroxide-vulcanizable composition may further comprise tackifier for adhesive applications (e.g., hot melt adhesive).

In embodiments, the tackifier may comprise hydrocarbon resin. Exemplary hydrocarbon resins may include aliphatic resins (e.g., C5 resins), aromatic resins (e.g., C9 resins), dicyclopentadiene resins, and resins including a combination of two or more of aliphatic monomers, aromatic monomers, and dicyclopentadiene. In embodiments, the hydrocarbon resin may be hydrogenated. In embodiments, the hydrocarbon resin may have a number average molecular weight of less than or equal to about 2,000 g/mol, less than or equal to about 1,500 g/mol, less than or equal to about 1,200 g/mol, less than or equal to about 1,100 g/mol, less than or equal to about 1,000 g/mol, or less than or equal to about 900 g/mol.

In embodiments, the peroxide-vulcanizable composition may comprise from about 15 wt % to about 50 wt % of the tackifier, or from about 17 wt % to about 40 wt % of the tackifier, or from about 20 wt % to about 30 wt % of the tackifier. In embodiments, the amount of tackifier in the peroxide-vulcanizable composition may be greater than or equal to about 15 wt %, greater than or equal to about 17 wt %, or even greater than or equal to about 20 wt %. In embodiments, the amount of tackifier in the peroxide-vulcanizable composition may be less than or equal to about 50 wt %, less than or equal to about 40 wt %, less than or equal to about 30 wt %, less than or equal to about 27 wt %, or even less than or equal to about 25 wt %. In embodiments, the amount of tackifier in the peroxide-vulcanizable composition may be from about 15 wt % to about 50 wt %, from about 15 wt % to about 40 wt %, from about 15 wt % to about 30 wt %, from about 15 wt % to about 27 wt %, from about 15 wt % to about 25 wt %, from about 17 wt % to about 50 wt %, from about 17 wt % to about 40 wt %, from about 17 wt % to about 30 wt %, from about 17 wt % to about 27 wt %, from about 17 wt % to about 25 wt %, from about 20 wt % to about 50 wt %, from about 20 wt % to about 40 wt %, from about 20 wt % to about 30 wt %, from about 20 wt % to about 27 wt %, or even from about 20 wt % to about 25 wt %, or any and all subranges formed from any of these endpoints.

Suitable commercial embodiments of the tackifier are available under the PLASTOLYN brand from Eastman Chemicals, such as grade R1140.

### Co-Volcanizable Polymer

In embodiments, the peroxide-vulcanizable composition may further comprise co-volcanizable polymer, which may be peroxide cured and crosslink with the thermoplastic elastomer.

In embodiments, the co-volcanizable polymer may comprise ethylene-vinyl acetate. In embodiments, the ethylene-vinyl acetate may have a vinyl acetate content greater than or equal to about 10 wt %, greater than or equal to about 25 wt %, greater than or equal to about 40 wt %, or even greater than or equal to 55 wt %, based on a total weight of the ethylene-vinyl acetate. In embodiments, the ethylene-vinyl acetate may have a vinyl acetate content less than or equal to about 80 wt %, less than or equal to about 70 wt %, or even less than or equal to about 60 wt %. In embodiments, the ethylene-vinyl acetate may have a vinyl acetate content from about 10 wt % to about 80 wt %, from about 10 wt % to about 70 wt %, from about 10 wt % to about 60 wt %, from about 25 wt % to about 80 wt %, from about 25 wt % to about 70 wt %, from about 25 wt % to about 60 wt %, from about 40 wt % to about 80 wt %, from about 40 wt % to about 70 wt %, from about 40 wt % to about 60 wt %, from about 55 wt % to about 80 wt %, from about 55 wt % to about 70 wt %, or even from about 55 wt % to about 60 wt %, or any and all sub-ranges formed from any of these endpoints.

In embodiments, the peroxide-vulcanizable composition may comprise from about 25 wt % to about 45 wt % of the copolymer, or from about 27 wt % to about 43 wt % of the copolymer, or from about 30 wt % to about 40 wt % of the copolymer. In embodiments, the amount of the copolymer in the peroxide-vulcanizable composition may be greater than or equal to about 25 wt %, greater than or equal to about 27 wt %, or even greater than or equal to about 30 wt %. In embodiments, the amount of the copolymer in the peroxide-vulcanizable composition may be less than or equal to about 45 wt %, less than or equal to about 43 wt %, or even less than or equal to about 40 wt %. In embodiments, the amount of the copolymer in the peroxide-vulcanizable composition may be from about 25 wt % to about 45 wt %, from about 25 wt % to about 43 wt %, from about 25 wt % to about 40 wt %, from about 27 wt % to about 45 wt %, from about 27 wt % to about 43 wt %, from about 27 wt % to about 40 wt %, from about 30 wt % to about 45 wt %, from about 30 wt % to about 43 wt %, or even from about 30 wt % to about 40 wt %, or any and all subranges formed from any of these endpoints.

Suitable commercial embodiments of the co-volcanizable polymer are available under the ELVAX brand from Dow Chemical Company, such as grade 265.

### Additives

In embodiments, the peroxide-vulcanizable composition may further comprise an additive. In embodiments, the additive may comprise adhesion promoters; biocides; anti-fogging agents; anti-static agents; blowing and foaming agents; bonding agents and bonding polymers; dispersants; flame retardants and smoke suppressants; mineral fillers; initiators; lubricants; micas; pigments, colorants, and dyes; processing aids; release agents; silanes, titanates, and zirconates; slip and anti-blocking agents; stearates; ultraviolet light absorbers; viscosity regulators; waxes; or combinations thereof.

### Partially Crosslinked Polymer System

The peroxide-vulcanizable compositions described herein may be used to form a partially crosslinked polymer system having an advantageous crosslink density (i.e., reduced tensile elongation at break) and heat resistance (i.e., reduced compression set) upon blending without the need for additional steps or materials. In embodiments, the partially crosslinked polymer system may be a thermoplastic vulcanizate.

The partially crosslinked polymer system disclosed herein may generally be described as a vulcanized, silane grafted thermoplastic elastomer with carbon-carbon bond crosslinks. In embodiments, the partially crosslinked polymer system may include carbon-carbon bond crosslinks and grafted silane moieties. In embodiments, the partially crosslinked polymer system includes carbon-carbon bond crosslinks and silane crosslinks. In embodiments, the extruded partially crosslinked polymer system may have a certain amount of silane crosslinks. Moisture may be required to achieve additional silane crosslinking.

In embodiments, the partially crosslinked polymer system may comprise a tensile elongation at break from about 30% to about 725%. In embodiments, the partially crosslinked polymer system may comprise a tensile elongation at break greater than or equal to about 30%, greater than or equal to about 50%, greater than or equal to about 100%, greater than or equal to about 150%, or even greater than or equal to about 200%. In embodiments, the partially crosslinked polymer system may comprise a tensile elongation at break less than or equal to about 725%, less than or equal to about 700%, less than or equal to about 650%, less than or equal to about 600%, less than or equal to about 550%, less than or equal to about 500%, or even less than or equal to about 450%. In embodiments, the partially crosslinked polymer system may comprise a tensile elongation at break from about 30% to about 725%, from about 30% to about 700%, from about 30% to about 650%, from about 30% to about 600%, from about 30% to about 550%, from about 30% to about 500%, from about 30% to about 450%, from about 50% to about 725%, from about 50% to about 700%, from about 50% to about 650%, from about 50% to about 600%, from about 50% to about 550%, from about 50% to about 500%, from about 50% to about 450%, from about 100% to about 725%, from about 100% to about 700%, from about 100% to about 650%, from about 100% to about 600%, from about 100% to about 550%, from about 100% to about 500%, from about 100% to about 450%, from about 150% to about 725%, from about 150% to about 700%, from about 150% to about 650%, from about 150% to about 600%, from about 150% to about 550%, from about 150% to about 500%, from about 150% to about 450%, from about 200% to about 725%, from about 200% to about 700%, from about 200% to about 650%, from about 200% to about 600%, from about 200% to about 550%, from about 200% to about 500%, or even from about 200% to about 450%, or any and all subranges formed from any of these endpoints.

In embodiments, the partially crosslinked polymer system may comprise a compression set from about 20% to about 90%, as measured at 100° C. In embodiments, the partially crosslinked polymer system may comprise a compression set greater than or equal to about 20%, greater than or equal to about 30%, greater than or equal to about 40%, or even greater than or equal to about 50%, as measured at 100° C. In embodiments, the partially crosslinked polymer system may comprise a compression set less than or equal to about 90%, less than or equal to about 80%, or even less than or equal to about 70%, as measured at 100° C. In embodiments, the partially crosslinked polymer system may comprise a compression set from about 20% to about 90%, from about 20% to about 80%, from about 20% to about 70%, from about 30% to about 90%, from about 30% to about 80%, from about 30% to about 70%, from about 40% to about 90%, from about 40% to about 80%, from about 40% to about 70%, from about 50% to about 90%, from about 50% to about 80%, or even from about 50% to about 70%, or any and all subranges formed from any of these endpoints.

In embodiments, the partially crosslinked polymer system may comprise a Shore A hardness greater than or equal to about 25, greater than or equal to about 30, greater than or equal to about 35, greater than or equal to about 40, or even greater than or equal to about 45. In embodiments, the partially crosslinked polymer system may comprise a Shore A hardness less than about 90, less than or equal to about 85, less than or equal to about 80, less than or equal to about 75, or even less than or equal to about 70. In embodiments, the partially crosslinked polymer system may comprise a Shore A hardness from about 25 to about 90, from about 25 to about 85, from about 25 to about 80, from about 25 to about 75, from about 25 to about 70, from about 30 to about 90, from about 30 to about 85, from about 30 to about 80, from about 30 to about 75, from about 30 to about 70, from about 35 to about 90, from about 35 to about 85, from about 35 to about 80, from about 35 to about 75, from about 35 to about 70, from about 40 to about 90, from about 40 to about 85, from about 40 to about 80, from about 40 to about 75, from about 40 to about 70, from about 45 to about 90, from about 45 to about 85, from about 45 to about 80, from about 45 to about 75, or even from about 45 to about 70, or any and all subranges from any of these endpoints.

In embodiments, the partially crosslinked polymer system may comprise a tensile strength at break greater than or equal to about 1.5 MPa, greater than or equal to about 2.0 MPa, greater than or equal to about 2.5 MPa, or even greater than or equal to about 3.0 MPa. In embodiments, the partially crosslinked polymer system may comprise a tensile strength at break less than or equal to about 8.0 MPa, less than or equal to about 7.5 MPa, less than or equal to about 7.0 MPa, less than or equal to about 6.5 MPa, or even less than or equal to about 6.0 MPa. In embodiments, the partially crosslinked polymer system may comprise a tensile strength at break from about 1.5 MPa to about 8.0 MPa, from about 1.5 MPa to about 7.5 MPa, from about 1.5 MPa to about 7.0 MPa, from about 1.5 MPa to about 6.5 MPa, from about 1.5 MPa to about 6.0 MPa, from about 2.0 MPa to about 8.0 MPa, from about 2.0 MPa to about 7.5 MPa, from about 2.0 MPa to about 7.0 MPa, from about 2.0 MPa to about 6.5 MPa, from about 2.0 MPa to about 6.0 MPa, from about 2.5 MPa to about 8.0 MPa, from about 2.5 MPa to about 7.5 MPa, from about 2.5 MPa to about 7.0 MPa, from about 2.5 MPa to about 6.5 MPa, from about 2.5 MPa to about 6.0 MPa, from about 3.0 MPa to about 8.0 MPa, from about 3.0 MPa to about 7.5 MPa, from about 3.0 MPa to about 7.0 MPa, from about 3.0 MPa to about 6.5 MPa, or even from about 3.0 MPa to about 6.0 MPa, or any and all subranges formed from any of these endpoints.

### Processing

In embodiments, the thermoplastic elastomer article described herein may be made with a batch process or continuous process.

In embodiments, the components of the peroxide-vulcanizable composition, including the thermoplastic elastomer, the organic peroxide, and the silane, may be added to an extruder (27 MM Leistriz Twin Extruder (L/D 52)) and blended. In embodiments, the blending (e.g., in the barrel of the extruder) may be carried out at a temperature from 150° C. to 220° C. In embodiments, the blending results in carbon-carbon bond crosslinking and grafted silane moieties on the thermoplastic elastomer.

As described herein, the vulcanization package of both organic peroxide and silane enables carbon-carbon bond crosslinking of the thermoplastic elastomer upon blending (e.g., within the extruder) without the need for additional steps or materials (e.g., moisture cure catalyst). Accordingly, in embodiments, the step of blending the thermoplastic elastomer, the organic peroxide, and the silane is performed in the absence of a catalyst. Moreover, the step of blending the thermoplastic elastomer, the organic peroxide, and the silane may be performed in the absence of a moisture (e.g., water). Accordingly, the silane may also be grafted to the thermoplastic elastomer in the extruder. However, due to the absence of moisture, silane crosslinking or does not occur in the extruder or—to the extent the any crosslinking happens by happenstance—occurs only to a very small degree in the extruder. Accordingly, upon exiting an extruder, the thermoplastic elastomer is free of silane graft to silane graft crosslinks or essentially free of silane graft to silane graft crosslinks.

In embodiments, upon extruding, the partially crosslinked polymer system has an extrusion tensile elongation at break greater than or equal to about 30% and a tensile elongation of the partially crosslinked polymer system remains within 5% of the extrusion tensile elongation at break for 24 hours at room temperature. In embodiments, upon extruding, the partially crosslinked polymer system has an extrusion compression set greater than or equal to about 20% and a compression set of the partially crosslinked polymer system remains within 5% of the extrusion compression set at break for 24 hours at room temperature.

Blending (also known as compounding) devices are well known to those skilled in the art and generally include feed means, especially at least one hopper for pulverulent materials and/or at least one injection pump for liquid materials; high-shear blending means, for example a co-rotating or counter-rotating twin-screw extruder, usually comprising a feed screw placed in a heated barrel (or tube); an output head, which gives the extrudate its shape; and means for cooling the extrudate, either by air cooling or by circulation of water. The extrudate is generally in the form of rods continuously exiting the device and able to be cut or formed into granules. However, other forms may be obtained by fitting a die of desired shape on the output die.

In embodiments, the carbon-carbon crosslinked, silane grafted blend is shaped.

In embodiments, the shaped carbon-carbon crosslinked, silane grafted blend may be aged (e.g., heat treated or cured) such that the partially crosslinked polymer system includes silane crosslinks.

### EXAMPLES

Table 1 below shows sources of ingredients used to form Comparative Examples C1-C10 and Examples E1-E22.

TABLE 1

| Ingredients | Brand | Source |
|---|---|---|
| para-methylstyrene-functional | SEPTON V9461 | Kuraray |
| styrene-ethylene-ethylene- | | |
| propylene-styrene | | |
| (PMS-functional SEEPS) | | |
| styrene-butadiene-styrene (SBS) | VECTOR 2518 | TSRC |
| styrene-isoprene-styrene (SIS) | VECTOR 4211 | TSRC |
| styrene-isoprene-styrene (SIS) | HYBRAR 5127 | Kuraray |
| styrene-ethylene-butylene-styrene | KRATON G1654 | Kraton |
| (SEBS) | (100% hydrogenation) | |
| partially hydrogenated styrene- | KRATON G1654 | Kraton |
| butadiene-styrene (SBS) | (85% hydrogenation) | |
| partially hydrogenated styrene- | KRATON G1654 | Kraton |
| butadiene-styrene (SBS) | (64% hydrogenation) | |
| styrene-ethylene-butylene-styrene | KRATON G1652 | Kraton |
| (SEBS) | (100% hydrogenation) | |
| partially hydrogenated styrene- | KRATON G1652 | Kraton |
| butadiene-styrene (SBS) | (90% hydrogenation) | |
| partially hydrogenated styrene- | KRATON G1652 | Kraton |
| butadiene-styrene (SBS) | (72% hydrogenation) | |
| partially hydrogenated styrene- | KRATON G1652 | Kraton |
| butadiene-styrene (SBS) | (64% hydrogenation) | |
| partially hydrogenated styrene- | TUFTECP 1083 | Ashai Kasei |
| butadiene-styrene (SBS) | (selective 1-2 hydrogenation) | |
| polypropylene (polyolefin) | FORMOLENE 1102KR | Formosa Plastics |
| ethylene-vinyl acetate (co- | ELVAX 265 | Dow Chemical Company |
| volcanizable polymer) | | |
| hydrocarbon resin (tackifier) | PLASTOLYN R1140 | Eastman Chemicals |
| antioxidant | IRGANOX 1010 | BASF |
| mineral oil (plasticizer) | PURETOL PSO 380 | Petro-Canada |
| vinyltrimethoxy silane (silane) | SILQUEST A-171 | Momentive |
| dicumyl peroxide | PERKADOX BC-FF | AkzoNobel |
| (organic peroxide) | | |

Tables 2-8 below show the formulations used to form and the certain properties of Comparative Examples C1-C10 and Examples E1-E22.

To prepare plaques for Examples E1-E22 and Comparative Examples C1-C10, the components of the formulations listed in Tables 2-8 were added into a 27 MM Leistriz Twin Extruder (L/D/52) and blended at barrel temperature of 193° C. and a rate of 5 rotations per second. The mixed formulation was extruded at a speed of 5 g/s.

Plaques of Examples E6 and E8 were aged after extrusion at the temperature and relative humidity (RH) for the time period listed in the tables prior to measuring the listed properties.

Comparative Examples C8 and C9 were blended with 1.5% tin catalyst master batch (MB) after extrusion. MB has a polyether carrier with 1.5% dibutylin dilaurate (MARK 1038, Galata Chemicals). The blended formulation was injection molded (i.e., shaped) to form a plaque. The plaque was conditioned at the temperature and relative humidity (RH) for the time period listed in the tables prior to measuring the listed properties.

TABLE 2

| | E1 | | E2 | | E3 | | E4 | |
|---|---|---|---|---|---|---|---|---|
| | Parts | Wt % | Parts | Wt % | Parts | Wt % | Parts | Wt % |
| SEPTON V9461 | 0 | 0 | 0 | 0 | 13 | 9.05 | 13 | 9.05 |
| VECTOR 2518 | 100.00 | 65.00 | 50 | 34.82 | 0 | 0 | 0 | 0 |
| VECTOR 4211 | 0 | 0 | 0 | 0 | 0 | 0 | 87 | 60.59 |
| HYBRAR 5127 | 0 | 0 | 0 | 0 | 87 | 60.59 | 0 | 0 |
| ELVAX 265 | 0 | 0 | 50 | 34.82 | 0 | 0 | 0 | 0 |
| FORMOLENE 1102K | 20 | 13.00 | 20 | 13.93 | 20 | 13.93 | 20 | 13.93 |
| PURETOL PSO 380 | 30 | 19.50 | 20 | 13.93 | 20 | 13.93 | 20 | 13.93 |
| SILQUEST A-171 | 3.23 | 2.10 | 3.02 | 2.10 | 3.02 | 2.10 | 3.02 | 2.10 |
| PERKADOX BC-FF | 0.61 | 0.40 | 0.57 | 0.40 | 0.57 | 0.40 | 0.57 | 0.40 |
| TOTAL | 153.84 | 100.00 | 143.59 | 100.00 | 143.59 | 100.00 | 143.59 | 100.00 |
| Hardness (Shore A) | 73 | | 80 | | 66 | | 65 | |
| Tensile strength | 5.7 | | 7.2 | | 7.0 | | 5.8 | |
| at break (MPa) | | | | | | | | |
| Tensile elongation | 160 | | 250 | | 180 | | 180 | |
| at break (%) | | | | | | | | |
| Compression set | 47 | | 54 | | 50 | | 54 | |
| (100° C., %) | | | | | | | | |

| | | |
|---|---|---|
| C1 | C2 | C3 |

| | Parts | Wt % | Parts | Wt % | Parts | Wt % |
|---|---|---|---|---|---|---|
| SEPTON V9461 | 0 | 0 | 0 | 0 | 13.00 | 9.29 |
| VECTOR 2518 | 100.00 | 66.67 | 50.00 | 35.71 | 0 | 0 |
| VECTOR 4211 | 0 | 0 | 0 | 0 | 0 | 0 |
| HYBRAR 5127 | 0 | 0 | 0 | 0 | 87.00 | 62.14 |
| ELVAX 265 | 0 | 0 | 50.00 | 35.71 | 0 | 0 |
| FORMOLENE 1102K | 20.00 | 13.33 | 20.00 | 14.29 | 20.00 | 14.29 |
| PURETOL PSO 380 | 30.00 | 20.00 | 20.00 | 14.29 | 20.00 | 14.29 |
| SILQUEST A-171 | 0 | 0 | 0 | 0 | 0 | 0 |
| PERKADOX BC-FF | 0 | 0 | 0 | 0 | 0 | 0 |
| TOTAL | 150.00 | 100.00 | 140.00 | 100.00 | 140.00 | 100.00 |

| | | | |
|---|---|---|---|
| Hardness (Shore A) | 71 | 77 | 53 |
| Tensile strength | 4.8 | 9.7 | 9.3 |

at break (MPa)

| | | | |
|---|---|---|---|
| Tensile elongation | 800 | 610 | 540 |

at break (%)

| | | | |
|---|---|---|---|
| Compression set | 100 | 100 | 100 |

(100° C., %)

TABLE 3

| | E5 | | E6 | | E7 | |
|---|---|---|---|---|---|---|
| | Parts | Wt % | Parts | Wt % | Parts | Wt % |
| KRATON G1654 | 0 | 0 | 0 | 0 | 0 | 0 |
| (100% hydrogenation) | | | | | | |
| KRATON G1654 | 100.00 | 45.56 | 100.00 | 45.56 | 0 | 0 |
| (85% hydrogenation) | | | | | | |
| KRATON G1654 | 0 | 0 | 0 | 0 | 100.00 | 45.56 |
| (64% hydrogenation) | | | | | | |
| FORMOLENE 1102K | 15.00 | 6.83 | 15.00 | 6.83 | 15.00 | 6.83 |
| PURETOL PSO 380 | 100.00 | 45.56 | 100.00 | 45.56 | 100.00 | 45.56 |
| SILQUEST A-171 | 3.89 | 1.77 | 3.89 | 1.77 | 3.89 | 1.77 |
| PERKADOX BC-FF | 0.60 | 0.27 | 0.60 | 0.27 | 0.60 | 0.27 |
| TOTAL | 219.49 | 100.00 | 219.49 | 100.00 | 219.49 | 100.00 |
| Aged | No | | Yes | | No | |
| (90° C./90% RH/6 days) | | | | | | |
| Hardness (Shore A) | 43 | | 48 | | 39 | |
| Tensile strength | 3.5 | | 4.8 | | 2.4 | |
| at break (MPa) | | | | | | |
| Tensile elongation | 340 | | 325 | | 210 | |
| at break (%) | | | | | | |
| Compression set | 66 | | 51 | | 48 | |
| (100° C., %) | | | | | | |

| | |
|---|---|
| E8 | C4 |

| | Parts | Wt % | Parts | Wt % |
|---|---|---|---|---|
| KRATON G1654 | 0 | 0 | 100.00 | 46.51 |
| (100% hydrogenation) | | | | |
| KRATON G1654 | 0 | 0 | 0 | 0 |
| (85% hydrogenation) | | | | |
| KRATON G1654 | 100.00 | 45.56 | 0 | 0 |
| (64% hydrogenation) | | | | |
| FORMOLENE 1102K | 15.00 | 6.83 | 15.00 | 6.98 |
| PURETOL PSO 380 | 100.00 | 45.56 | 100.00 | 46.51 |
| SILQUEST A-171 | 3.89 | 1.77 | 0 | 0 |
| PERKADOX BC-FF | 0.60 | 0.27 | 0 | 0 |
| TOTAL | 219.49 | 100.00 | 215.00 | 100.00 |

| | | |
|---|---|---|
| Aged | Yes | No |

(90° C./90% RH/6 days)

| | | |
|---|---|---|
| Hardness (Shore A) | 41 | 37 |
| Tensile strength | 3.1 | 2.6 |

at break (MPa)

| | | |
|---|---|---|
| Tensile elongation | 230 | 590 |

at break (%)

| | | |
|---|---|---|
| Compression set | 47 | 79 |

(100° C., %)

TABLE 4

| | E9 | | E10 | | E11 | |
|---|---|---|---|---|---|---|
| | Parts | Wt % | Parts | Wt % | Parts | Wt % |
| KRATON G1654 | 0 | 0 | 0 | 0 | 0 | 0 |
| (100% hydrogenation) | | | | | | |
| KRATON G1654 | 100.00 | 49.25 | 100.00 | 48.50 | 0 | 0 |
| (85% hydrogenation) | | | | | | |
| KRATON G1654 | 0 | 0 | 0 | 0 | 100.00 | 49.25 |
| (64% hydrogenation) | | | | | | |
| PLASTOLYN R1140 | 50.00 | 24.63 | 50.00 | 24.25 | 50.00 | 24.63 |
| PURETOL PSO 380 | 50.00 | 24.63 | 50.00 | 24.25 | 50.00 | 24.63 |
| SILQUEST A-171 | 2.64 | 1.30 | 5.36 | 2.60 | 2.64 | 1.30 |
| PERKADOX BC-FF | 0.40 | 0.20 | 0.82 | 0.40 | 0.40 | 0.20 |
| TOTAL | 203.04 | 100.00 | 206.18 | 100.00 | 203.04 | 100.00 |
| Hardness (Shore A) | 32 | | 30 | | 32 | |
| Tensile strength | 2.5 | | 2.2 | | 1.8 | |
| at break (MPa) | | | | | | |
| Tensile elongation | 660 | | 460 | | 310 | |
| at break (%) | | | | | | |
| Compression set | 86 | | 85 | | 73 | |
| (100° C., %) | | | | | | |

| | |
|---|---|
| E12 | C5 |

| | Parts | Wt % | Parts | Wt % |
|---|---|---|---|---|
| KRATON G1654 | 0 | 0 | 100.00 | 50.00 |
| (100% hydrogenation) | | | | |
| KRATON G1654 | 0 | 0 | 0 | 0 |
| (85% hydrogenation) | | | | |
| KRATON G1654 | 100.00 | 48.50 | 0 | 0 |
| (64% hydrogenation) | | | | |
| PLASTOLYN R1140 | 50.00 | 24.25 | 50.00 | 25.00 |
| PURETOL PSO 380 | 50.00 | 24.25 | 50.00 | 25.00 |
| SILQUEST A-171 | 5.36 | 2.60 | 0 | 0 |
| PERKADOX BC-FF | 0.82 | 0.40 | 0 | 0 |
| TOTAL | 206.18 | 100.00 | 200.00 | 100.00 |

| | | |
|---|---|---|
| Hardness (Shore A) | 30 | 31 |
| Tensile strength | 1.8 | 2.4 |

at break (MPa)

| | | |
|---|---|---|
| Tensile elongation | 250 | 580 |

at break (%)

| | | |
|---|---|---|
| Compression set | 66 | 80 |

(100° C., %)

TABLE 5

| | E13 | | E14 | | E15 | | C6 | |
|---|---|---|---|---|---|---|---|---|
| | Parts | Wt % | Parts | Wt % | Parts | Wt % | Parts | Wt % |
| KRATON G1652 | 0 | 0 | 0 | 0 | 0 | 0 | 100.00 | 71.43 |
| (100% hydrogenation) | | | | | | | | |
| KRATON G1652 | 100.00 | 69.64 | 0 | 0 | 0 | 0 | 0 | 0 |
| (90% hydrogenation) | | | | | | | | |
| KRATON G1652 | 0 | 0 | 100.00 | 69.64 | 0 | 0 | 0 | 0 |
| (72% hydrogenation) | | | | | | | | |
| KRATON G1652 | 0 | 0 | 0 | 0 | 100.00 | 69.73 | 0 | 0 |
| (64% hydrogenation) | | | | | | | | |
| FORMOLENE 1102K | 10.00 | 6.96 | 10.00 | 6.96 | 10.00 | 6.97 | 10.00 | 7.14 |
| PURETOL PSO 380 | 30.00 | 20.89 | 30.00 | 20.89 | 30.00 | 20.92 | 30.00 | 21.43 |
| SILQUEST A-171 | 3.02 | 2.10 | 3.02 | 2.10 | 3.07 | 2.14 | 0 | 0 |
| PERKADOX BC-FF | 0.57 | 0.40 | 0.57 | 0.40 | 0.34 | 0.24 | 0 | 0 |
| TOTAL | 143.59 | 100.00 | 143.59 | 100.00 | 143.41 | 100.00 | 140.00 | 100.00 |
| Hardness (Shore A) | 60 | | 59 | | 58 | | 63 | |
| Tensile strength | 5.3 | | 4.8 | | 4.9 | | 7.4 | |
| at break (MPa) | | | | | | | | |
| Tensile elongation | 350 | | 180 | | 160 | | 570 | |
| at break (%) | | | | | | | | |
| Compression set | 86 | | 79 | | 60 | | 100 | |
| (100° C., %) | | | | | | | | |

TABLE 6

| | E16 | | E17 | | C7 | |
|---|---|---|---|---|---|---|
| | Parts | Wt % | Parts | Wt % | Parts | Wt % |
| KRATON G1652 | 0 | 0 | 0 | 0 | 100.00 | 55.56 |
| (100% hydrogenation) | | | | | | |
| KRATON G1652 | 100.00 | 54.69 | 100.00 | 54.25 | 0 | 0 |
| (64% hydrogenation) | | | | | | |
| PLASTOLYN R1140 | 40.00 | 21.87 | 40.00 | 21.70 | 40.00 | 22.22 |
| PURETOL PSO 380 | 40.00 | 21.87 | 40.00 | 21.70 | 40.00 | 22.22 |
| SILQUEST A-171 | 2.57 | 1.41 | 3.90 | 2.12 | 0 | 0 |
| PERKADOX BC-FF | 0.29 | 0.16 | 0.43 | 0.23 | 0 | 0 |
| TOTAL | 182.86 | 100.00 | 184.33 | 100.00 | 180.00 | 100.00 |
| Hardness (Shore A) | 31 | | 36 | | 39 | |
| Tensile strength | 3.2 | | 3.4 | | 6.4 | |
| at break (MPa) | | | | | | |
| Tensile elongation | 600 | | 470 | | 800 | |
| at break (%) | | | | | | |
| Compression set | 80 | | 56 | | 100 | |
| (100° C., %) | | | | | | |

TABLE 7

| | E18 | | C8 | | E19 | | C9 | |
|---|---|---|---|---|---|---|---|---|
| | Parts | Wt % | Parts | Wt % | Parts | Wt % | Parts | Wt % |
| KRATON G1654 | 100.00 | 45.56 | 100.00 | 45.56 | 0 | 0 | 0 | 0 |
| (85% hydrogenation) | | | | | | | | |
| KRATON G1654 | 0 | 0 | 0 | 0 | 100.00 | 45.56 | 100.00 | 45.56 |
| (64% hydrogenation) | | | | | | | | |
| FORMOLENE 1102K | 15.00 | 6.83 | 15.00 | 6.83 | 15.00 | 6.83 | 15.00 | 6.83 |
| PURETOL PSO 380 | 100.00 | 45.56 | 100.00 | 45.56 | 100.00 | 45.56 | 100.00 | 45.56 |
| SILQUEST A-171 | 3.89 | 1.77 | 3.89 | 1.77 | 3.89 | 1.77 | 3.89 | 1.77 |
| PERKADOX BC-FF | 0.60 | 0.27 | 0.60 | 0.27 | 0.60 | 0.27 | 0.60 | 0.27 |
| TOTAL | 219.49 | 100.00 | 219.49 | 100.00 | 219.49 | 100.00 | 219.49 | 100.00 |
| 1.5% catalyst MB and | No | | Yes | | No | | Yes | |
| aged (90° C./90% RH/24 | | | | | | | | |
| hours) | | | | | | | | |
| Hardness (Shore A) | 43 | | 48 | | 39 | | 42 | |
| Tensile strength | 3.5 | | 4.1 | | 2.4 | | 2.8 | |
| at break (MPa) | | | | | | | | |
| Tensile elongation | 340 | | 235 | | 210 | | 180 | |
| at break (%) | | | | | | | | |
| Compression set | 66 | | 49 | | 48 | | 44 | |
| (100° C., %) | | | | | | | | |

TABLE 8

| | E20 | | E21 | | E22 | | C10 | |
|---|---|---|---|---|---|---|---|---|
| | Parts | Wt % | Parts | Wt % | Parts | Wt % | Parts | Wt % |
| KRATON G1652 | 0 | 0 | 0 | 0 | 0 | 0 | 100.00 | 71.29 |
| (100% hydrogenation) | | | | | | | | |
| TUFTEC P 1083 | 100.00 | 70.62 | 100.00 | 70.51 | 100.00 | 70.37 | 0 | 0 |
| (selective 1-2 | | | | | | | | |
| hydrogenation) | | | | | | | | |
| FORMOLENE 1102K | 10.00 | 7.06 | 10.00 | 7.05 | 10.00 | 7.04 | 10.00 | 7.13 |
| PURETOL PSO 380 | 30.00 | 21.18 | 30.00 | 21.15 | 30.00 | 21.11 | 30.00 | 21.39 |
| IRGANOX 1010 | 0.28 | 0.20 | 0.28 | 0.20 | 0.28 | 0.20 | 0.28 | 0.20 |
| SILQUEST A-171 | 1.14 | 0.81 | 1.32 | 0.93 | 1.56 | 1.10 | 0 | 0 |
| PERKADOX BC-FF | 0.19 | 0.13 | 0.22 | 0.16 | 0.26 | 0.18 | 0 | 0 |
| TOTAL | 141.61 | 100.00 | 141.82 | 100.00 | 142.10 | 100.00 | 140.28 | 100.00 |
| Hardness (Shore A) | 53 | | 53 | | 52 | | 63 | |
| Tensile strength | 4.7 | | 4.6 | | 4.3 | | 7.4 | |
| at break (MPa) | | | | | | | | |
| Tensile clongation | 410 | | 340 | | 290 | | 570 | |
| at break (%) | | | | | | | | |
| Compression set | 74 | | 58 | | 55 | | 100 | |
| (100° C., %) | | | | | | | | |

As shown in Tables 2-8, Examples E1-E22, partially crosslinked polymer systems formed from a peroxide-vulcanizable composition including a thermoplastic elastomer, silane (SILQUEST A-171), and organic peroxide (PERKADOX BC-FF) showed a reduced tensile elongation at break and a reduced compression set as compared to Comparative Examples C1-C10, non-crosslinked thermoplastic articles formed from a composition including a thermoplastic elastomer without silane and organic peroxide. As indicated by Examples E1-E22 and Comparative Examples C1-C10, a peroxide-vulcanizable composition including a thermoplastic elastomer, silane, and organic peroxide results in a partially crosslinked polymer system having improved crosslink density and heat resistance as compared to an article that was not formed with a composition including silane and organic peroxide.

As shown in Table 3, Example E7, a partially crosslinked polymer system formed from a peroxide-vulcanizable composition including a thermoplastic elastomer having 64% hydrogenation (KRATON G1654 (64% hydrogenation)) showed a reduced tensile elongation at break and a reduced compression set as compared to Example E5, a partially crosslinked polymer system formed from a peroxide-vulcanizable composition including a thermoplastic elastomer having 85% hydrogenation (KRATON G1654 (85% hydrogenation)). As indicated by Examples E5 and E7, reducing the degree of hydrogenation of a thermoplastic elastomer in the peroxide-vulcanizable composition improves the crosslink density and heat resistance of the resulting partially crosslinked polymer system.

As also shown in Table 3, Example E6, a partially crosslinked polymer system formed from a peroxide-vulcanizable composition including silane and aged, showed a reduced tensile elongation at break and a reduced compression set as compared to Example E5, a partially crosslinked polymer system formed from a peroxide-vulcanizable composition including silane and not aged. As indicated by Examples E5 and E6, aging the partially crosslinked polymer system in the presence of moisture results in silane crosslinking, which further improves the crosslink density and heat resistance.

As shown in Table 4, Examples E11 and E12, partially crosslinked polymer systems formed from a peroxide-vulcanizable composition including a thermoplastic elastomer having 64% hydrogenation (KRATON G1654 (64% hydrogenation)), showed a reduced tensile elongation at break and a reduced compression set as compared to Examples E9 and E10, partially crosslinked polymer systems formed from a peroxide-vulcanizable composition including a thermoplastic elastomer having 85% hydrogenation (KRATON G1654 (85% hydrogenation)). As indicated by Examples E9-E12, reducing the degree of hydrogenation of a thermoplastic elastomer in the peroxide-vulcanizable composition improves the crosslink density and heat resistance of the resulting partially crosslinked polymer system.

As also shown in Table 4, Examples E10 and E12, partially crosslinked polymer systems formed from a peroxide-vulcanizable composition including 0.40 wt % organic peroxide (PERKADOX BC-FF), showed a reduced tensile elongation at break and a reduced compression set as compared to Examples E9 and E11, respectively, partially crosslinked polymer systems formed from a peroxide-vulcanizable composition including 0.20 wt % organic peroxide. As indicated by Examples E9-E12, increasing the organic peroxide amount in the peroxide-vulcanizable composition improves the crosslink density and heat resistance of the resulting partially crosslinked polymer system.

As shown in Table 5, Example E15, a partially crosslinked polymer system formed from a peroxide-vulcanizable composition including a thermoplastic elastomer having 64% hydrogenation (KRATON G1652 (64% hydrogenation)), showed a reduced tensile elongation at break and a reduced compression set as compared to Example E14, a partially crosslinked polymer system formed from a peroxide-vulcanizable composition including a thermoplastic elastomer having 85% hydrogenation (KRATON G1652 (85% hydrogenation)). Example E14 showed a reduced tensile elongation at break and a reduced compression set as compared to Example E13, a partially crosslinked polymer system formed from a peroxide-vulcanizable composition including a thermoplastic elastomer having 90% hydrogenation (KRATON G1652 (90% hydrogenation)). As indicated by Examples E13-E15, reducing the degree of hydrogenation of a thermoplastic elastomer in the peroxide-vulcanizable composition improves the crosslink density and heat resistance of the resulting partially crosslinked polymer system.

As shown in Table 7, Examples E18 and E19, partially crosslinked polymer systems formed from a peroxide-vulcanizable composition without a catalyst, achieved a desirable tensile elongation at break (e.g., greater than or equal to 30%) at break and compression set (e.g., greater than or equal to 20%) as compared to Comparative Examples C8 and C9, partially crosslinked polymer systems formed from a peroxide-vulcanizable composition with a catalyst and aged. As indicated by Examples E18 and E19 and Comparative Examples C8 and C9, improved crosslink density and heat resistance may be achieved upon blending without the need for additional steps or materials.

As shown in Table 8, Example E22, a partially crosslinked polymer system formed from a peroxide-vulcanizable composition including 0.18 wt % organic peroxide (PERKADOX BC-FF), showed a reduced tensile elongation at break and a reduced compression set as compared to Example E21, a partially crosslinked polymer system formed from a peroxide-vulcanizable composition including 0.16 wt % organic peroxide. Example E21 showed a reduced tensile elongation at break and a reduced compression set as compared to Example E20, a partially crosslinked polymer system formed from a peroxide-vulcanizable composition including 0.13 wt % organic peroxide. As indicated by Examples E20-E22, increasing the organic peroxide amount in the peroxide-vulcanizable composition improves the crosslink density and heat resistance of the resulting partially crosslinked polymer system.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A partially crosslinked polymer system comprising:
a vulcanized, silane grafted thermoplastic elastomer that includes carbon-carbon bond crosslinks,
the silane grafted thermoplastic elastomer comprising a polymerized reaction product of vinyl aromatic monomers and conjugated diene monomers.

2. The partially crosslinked polymer system of claim 1, wherein the partially crosslinked polymer system has
a tensile elongation at break from about 30% to about 725%; and
a compression set from about 20% to about 90%, as measured at 100° C.

3.-4. (canceled)

5. The partially crosslinked polymer system of claim 1, wherein the thermoplastic elastomer is selected from the group consisting of styrene-butadiene rubber, styrene-butadiene block copolymers, styrene-isoprene block copolymers, styrene-butadiene-isoprene rubber, styrene-butadiene/isoprene block copolymers, styrene-butadiene-isoprene block copolymers, partially hydrogenated styrene-butadiene rubber, partially hydrogenated styrene-butadiene block copolymers, partially hydrogenated styrene-isoprene block copolymers, partially hydrogenated styrene-butadiene-isoprene rubber, partially hydrogenated styrene-butadiene/isoprene block copolymers, partially hydrogenated styrene-butadiene-isoprene block copolymers, and combinations thereof.

6. The partially crosslinked polymer system of claim 1, wherein the thermoplastic elastomer is a block copolymer that includes a block defined by formula (I): 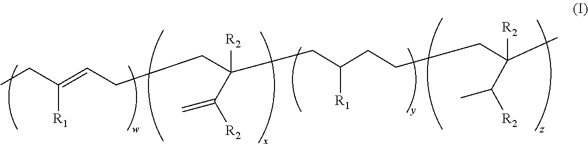
wherein the w, x, y, and z units are randomly distributed in the block, each R₁ is independently a hydrogen atom or a methyl group, each R₂ is independently a hydrogen atom or a methyl group with the proviso that at least one R₂ per unit is a hydrogen atom; and the molar percent of the sum of the y and z units out of the total sum of the w, x, y, and z units in the block is from about 30% to about 90%.

7. (canceled)

8. The partially crosslinked polymer system of claim 6, wherein the ratio of y units to w units is greater than the ratio of x units to z units.

9. The partially crosslinked polymer system of claim 6, wherein the ratio of y units to w units is less than the ratio of x units to z units.

10. The partially crosslinked polymer system of claim 1, wherein the thermoplastic elastomer is a block copolymer that includes a block defined by formula (II): 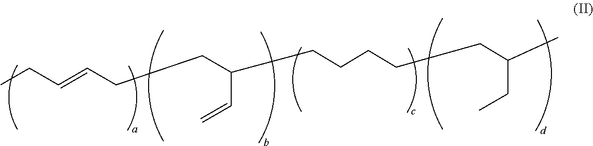
wherein the a, b, c, and d units are randomly distributed in the block, and the molar percent of the sum of the c units and d units out of the total sum of the a, b, c, and d units in the block is from about 30% to about 90%.

11. (canceled)

12. The partially crosslinked polymer system of claim 10, wherein the ratio of c units to a units is greater than the ratio of d units to b units.

13. The partially crosslinked polymer system of claim 10, wherein the ratio of c units to a units is less than the ratio of d units to b units.

14. The partially crosslinked polymer system of claim 1, wherein the thermoplastic elastomer has a number average molecular weight from about 30,000 g/mol to about 400,000 g/mol.

15. The partially crosslinked polymer system of claim 1, wherein the thermoplastic elastomer is a triblock copolymer that includes two polystyrene end blocks, and wherein the styrene content of the two polystyrene end blocks in the thermoplastic elastomer is from about 10 wt % to about 50 wt %.

16. The partially crosslinked polymer system of claim 1, wherein the partially crosslinked polymer system is a block copolymer having a hard phase and a soft phase, the general configuration being:
A-B,
A-B-A, or
A-B-A′, wherein
each A and A′ blocks a hard phase comprising vinyl aromatic monomeric units and each B block is a soft phase comprising conjugated diene monomeric units.

17. The partially crosslinked polymer system of claim 1, wherein the partially crosslinked polymer system silane crosslinks.

18. The partially crosslinked polymer system of claim 1, the partially crosslinked polymer system is a thermoplastic vulcanizate.

19. The partially crosslinked polymer system of claim 1, the partially crosslinked polymer system further comprises an olefin polymer.

20.-58. (canceled)

59. A process for making a partially crosslinked polymer system comprising a crosslinked reaction product of a thermoplastic elastomer comprising vinyl aromatic monomeric units and conjugated diene monomeric units and a vulcanization package comprising an organic peroxide and a silane, the process comprising the steps of:
blending the thermoplastic elastomer, the organic peroxide, and the silane such that the thermoplastic elastomer includes carbon-carbon bond crosslinks and grafted silane moieties; and
extruding the carbon-carbon crosslinked, silane-grafted blend.

60. The process of claim 59, wherein the step of blending the thermoplastic elastomer, organic peroxide, and silane is performed in the absence of a catalyst.

61. The process of claim 59, wherein the step of blending the thermoplastic elastomer, organic peroxide, and silane is performed in the absence of moisture.

62. The process of claim 59, wherein upon extruding, partially crosslinked polymer system has an extrusion tensile elongation at break greater than or equal to about 30% and a tensile elongation of the partially crosslinked polymer system remains within 5% of the extrusion tensile elongation at break for 24 hours at room temperature.

63. (canceled)
